(19) United States
(12) Patent Application Publication
(10) Pub. No.: US 2002/0035694 A1
(43) Pub. Date: Mar. 21, 2002

(54) Method and apparatus for anonymous remote transactions

(75) Inventors: Nachum Frenkel, Tel Aviv (IL); Yoran Frenkel, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Global E-cash Inc.

(21) Appl. No.: 09/953,207

(22) Filed: Sep. 17, 2001

Related U.S. Application Data
(60) Provisional application No. 60/232,832, filed on Sep. 15, 2000.

(51) Int. Cl. H04L 9/00; G06F 17/60

(52) U.S. Cl. 713/193; 705/65

(57) ABSTRACT

Apparatus for anonymous remote transactions over a network comprising a computer readable data unit, a host storing a record of a sum of money associated with said computer readable data unit, and a transaction unit for identifying said associated record at said host on the basis of data obtained from said computer readable data unit, and debiting said associated record in accordance with a transaction being carried out by a user.

### RELATIONSHIP WITH EXISTING APPLICATIONS

The present application claims priority from U.S. provisional application No. 60/232,832 dated Sep. 15, 2000.

### FIELD OF THE INVENTION

The present invention relates to a method and apparatus for anonymous remote transactions and more particularly but not exclusively to a method and apparatus which is not only anonymous but also regarded as reliable by another party to the transaction and which includes elements of protection against misuse.

### BACKGROUND OF THE INVENTION

Currently, whilst there are ever growing numbers of users of the Internet, the extent of actual business transactions carried out on the net has not kept pace, largely because users are reluctant to give out credit card or bank account numbers over the network and do not trust secure links. Even if the network is secure there is distrust as to possible misuse of the information by the other party to the transaction.

A further problem with transactions on the Internet is that it is often desirable to carry out small transactions, for example to allow downloading of a videoclip or other multimedia data. Such small transactions are below the threshold at which it is worthwhile using a credit card.

Several trends motivate the need for small-sized financial transactions, often called microtransactions. First, the fine granularity of information on the World Wide Web (WWW) and competition with free information on the WWW gives rise to the need to pay very small amounts for information sold on the WWW. Second, the growing number of embedded processing elements in our everyday environment motivates the need for small payments as a technique for controlling our environment.

There is no well established definition of a microtransaction. Its principal characteristic is small size and overhead. As a result, microtransactions should be off-line from a central server, and easy to compute; however, most current electronic payment protocols are computationally intensive and/or require a great deal of memory space and are thus not suitable for microtransactions.

Accordingly, a need exits for a space efficient microtransaction protocol that is suited to the limited processing and memory capabilities of small portable computation platforms, like smart cards and personal digital assistants (PDAs).

The problem of misuse by the other party to the transaction can be solved by making the transaction anonymous. That is to say no information is sent to the other party that allows for identification of the first party. One attempt to achieve this is shown in U.S. Pat. No. 5,857,023, which discloses a method of redeeming for a seller electronic payments generated by and received from a customer using a master key unknown to the seller. In anticipation of making electronic payments, a customer sends a bank the master key that he will use to generate electronic payments. The bank stores the master key. Later, the bank receives from the seller a redemption request including a seller identifier, a first value of a payment index, and an electronic payment associated with the first value of the payment index. The bank authenticates the electronic payment by comparing the electronic payment to a hash of a string including the master key, the seller identifier, and the first value of the payment index. If the electronic payment is authenticated, the bank determines an amount due to the seller.

A number of methods exist which use prepaid cards and the like. However these are not generally useful for Internet transactions simply because the cards cannot be read by a standard computer. An example of such a system is disclosed in U.S. Pat. No. 5,485,520. This citation shows a method of automatic electronic payment for motorway tolls and the like, using smart cards containing prepaid sums, that can be debited automatically and anonymously. One or more roadside collection stations (RCS) communicate over a short-range, high speed bidirectional microwave communication link with one or more in-vehicle units (IVU) associated with one or more respectively corresponding vehicles in one or more traffic lanes of a highway. At least two up-link (IVU to RCS) communication sessions and at least one downlink (RCS to IVU) communication session are transacted in real time during the limited duration of an RCS communication footprint as the vehicle travels along its lane past a highway toll plaza. Especially efficient data formatting and processing is utilized so as to permit, during this brief interval, computation of the requisite toll amount and a fully verified and cryptographically secured (preferably anonymous) debiting of a smart card containing electronic money. Preferably an untraceable electronic check is communicated in a cryptographically sealed envelope with opener. Transaction linkage data is utilized in each phase of the complete toll payment transaction to facilitate simultaneous multi-lane RCS/IVU operation. A plaza computer local area network and downlink plaza controller is also used to facilitate simultaneous multi-lane transactions.

There is currently a need for a payment means that is anonymous but trustworthy to other parties, does not involve a large amount of calculation, is suitable for small transactions, contains some form of built in protection against theft and fraud, and is compatible with home and office computers.

### SUMMARY OF THE INVENTION

According to a first aspect of the present invention there is thus provided apparatus for anonymous remote transactions over a network comprising

a computer readable data unit,

a host storing a record of a sum of money associated with said computer readable data unit, and

a transaction unit for identifying said associated record at said host on the basis of data obtained from said computer readable data unit, and debiting said associated record in accordance with a transaction being carried out by a user.

Preferably, said computer readable data unit is embodied on substantive media.

Preferably, said computer readable data unit is operable to issue encrypted data readable only by said transaction unit.

Preferably, said computer readable data unit is operable to issue data readable only at said host.

Preferably, said information obtained from said computer readable data unit is information indicative only of said associated record.

Preferably, said computer readable data unit comprises operating software operable to manage said transaction automatically at a user end computer.

Preferably, said operating software is operable to permit said transaction to be carried out with a single user data interaction.

Preferably, in said operating program is operable to start automatically upon insertion of said computer readable data unit into a user end computer.

Preferably, said associated record indicates prepaid cash.

Preferably, said prepaid cash is renewable.

Preferably, said computer readable data unit is one of a group comprising a CD Rom, a DVD Rom and a minidisk Rom.

Preferably, the computer readable data unit is substantially the size of a credit card.

Preferably, the computer readable data unit is substantially the shape of a credit card.

Preferably, the computer readable data unit is one of a batch of such units, said batch having an initialization member and wherein the batch is activatable by means of use together with a password of said initialization member.

Preferably, said single data interaction is operable to initiate at least one of a group of activities comprising:

opening a network contract,

indicating conditions of a contract,

confirming acceptance of contract conditions,

sending a request to make a payment to a supplier, and

obtaining details of an account to credit.

Preferably, said group of activities further comprises the use of an electronic signature.

Preferably, said host is operable to show to a user over a network a balance remaining, said balance being indicated by said associated record.

Preferably, said data obtained is unchanged throughout the life of the computer readable data unit but wherein said unit comprises an encrypting unit operable to encrypt said data in different ways.

Preferably, said computer readable data unit comprises an encrypting unit operable to encrypt said data obtained, which said encryption unit is operable to add random bits to said data prior to encrypting said data.

According to a second aspect of the present invention there is provided a prepaid transaction unit representing prepaid electronic cash units for use in remote transactions, which card is embodied on a machine readable media in association with operating software for supporting said transaction.

The prepaid transaction unit preferably comprises automatic activation for automatically activating said operating software on insertion of said prepaid transaction unit into a reader of an electronic computer.

Preferably, said operating software further comprises a network access unit for accessing a server via a network to allow said software to determine the current value of remaining prepaid cash units associated with said card, said current value being located on said server.

Preferably, said software is further operable to update said current value in the light of a present transaction.

Preferably, said software is further operable to obtain details of an account associated with a beneficiary of said present transaction and to credit said account.

The prepaid transaction unit preferably comprises a secret key for accessing said current value at said server.

The prepaid transaction unit preferably comprises a secret key for accessing said server.

According to a third aspect of the present invention there is provided a prepayment card on computer readable media.

The prepayment card preferably comprises software for activating a computer on which said card is inserted, to connect via a network to a server to update an account located on said server and associated with said prepayment card.

According to a fourth aspect of the present invention there is provided a method of activating a prepayment card associated with an account at a server, which card is one of a consignment of prepayment cards, comprising the steps of

initially blocking access by said card to said associated account,

selecting an enabler key,

connecting to said server using said selected enabler key,

using said key via said connection,

enabling access by said card to said associated account upon use of said key.

### BRIEF DESCRIPTION OF THE DRAWINGS

For a better understanding of the invention and to show how the same may be carried into effect, reference will now be made, purely by way of example, to the accompanying drawings, in which:

FIG. 1 is a simplified diagram showing a prepayment card operative in accordance with a first embodiment of the present invention,

FIG. 2 is a simplified block diagram showing software elements within the prepayment card of FIG. 1,

FIG. 3 is a simplified diagram illustrating storage of accounts for prepaid cards, the accounts located within a server operative in accordance with an embodiment of the present invention,

FIG. 4 is a simplified diagram illustrating the use of the prepaid card of FIG. 1 over a network, and

FIG. 5 is a simplified diagram showing a user screen for carrying out a transaction using the prepaid card of FIG. 1.

### DESCRIPTION OF THE PREFERRED EMBODIMENTS

Embodiments of the present invention provide a prepaid card which is preferably the size and shape of a credit card and which comprises a machine readable or digitally readable medium. The card may be inserted into a digital reader such as a CD ROM reader of a computer. The machine readable part of the card preferably comprises an auto-start feature and contains programming to allow transaction details to be entered, and to allow the computer to connect to a server via a network such as the Internet. The server preferably comprises an account associated with each card. The account initially contains an amount purchased with the card, which amount is decremented over successive transactions. Since the account is prepaid, the beneficiary of the payment receives a credit from the prepaid card vendor and not from the purchaser, and thus the card provides anonymous payment over the Internet.

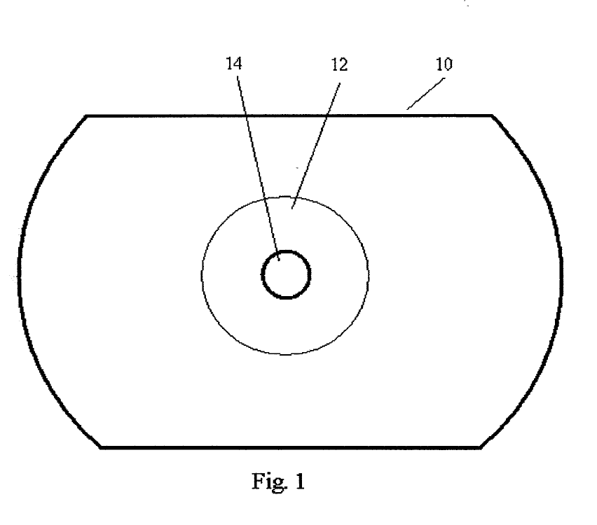

Reference is now made to FIG. 1, which shows a prepaid card 10, preferably having the size and shape of a credit card so as to fit conveniently into a cardholder in a wallet. The prepaid card comprises a machine readable region 12, preferably a CD Rom, which is readable by a standard CD Rom drive. Due to the size of the card 10 the machine readable part 12 is smaller than the standard CD Rom size. A standard CD central hole 14 is sufficient for centering the Rom for successful reading in many CD Rom drives but for others it may be necessary to provide guidance protrusions.

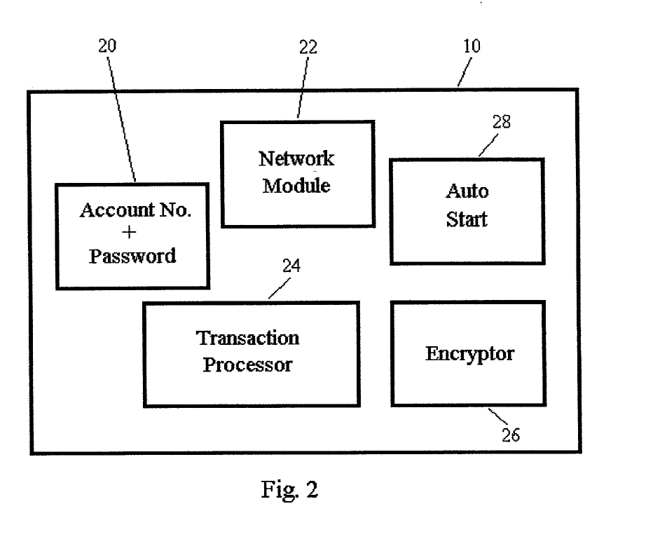

Reference is now made to FIG. 2, which is a simplified block diagram of software elements preferably included in the machine readable region 12 of prepaid card 10. As mentioned above, the machine readable region 12 is preferably a CD Rom which cannot be written to and therefore cannot be used to encode variable quantities such as the amount remaining on the card. Rather, the card 10 contains an access means for accessing a server, the server having an account corresponding to the card and wherein all variable data relating to the card is stored. An access unit 20 on the prepaid card 10 preferably contains data to access the unique account associated with the card, such data typically being an account number and a secret key or password.

The card preferably also comprises a network module. The network module is preferably able to identify and make use of any networking capability on a host computer so as to connect to an Internet presence, such as a web page, of a host server on which the associated account is stored. The network module may be operable to determine that a network connection is present. If so it will determine direct a browser to obtain the correct web page, automatically enter the necessary account identification information and key, and also use the browser to display any output for the user such as an interactive form for input of data regarding the present transaction.

If no Internet connection is found to be active, then the network module 22 is preferably operable to launch the dial-up connection on the host computer. In many operating systems this too can be performed simply by launching the browser.

The prepaid card 10 preferably further comprises a transaction processor 24. The transaction processor 24 comprises operability needed locally in order to support transactions carried out with the card. For example the transaction processor may support software for requesting a transaction price from a user and the like. In a preferred embodiment the transaction processor is embodied as a module intended for interaction with a web browser. It may for example be in the form of a plug-in or a java applet.

A preferred embodiment also comprises an encryptor 26. The encryptor 26 may again be embodied as a browser plug-in or a java applet or the like. The encryptor is preferably operable to encrypt transaction data for communication with the server.

In one preferred embodiment, the encryptor 26 is not explicitly provided on the prepaid card, but rather use is made of a security plug-in included with the host browser. In another preferred embodiment, one or more of the features of the transaction processor 24 and the encryptor 26 are not explicitly provided on the prepaid card 10 but are downloaded from the server upon making a connection. In yet another preferred embodiment, the software on the prepaid card is operable to detect whether suitable programs are present on the host computer and, if not, it is operable either to download from the server or load from the prepaid card as appropriate.

Preferably, there is further provided an auto-start feature 28 on the pre-paid card. The auto-start feature 28 allows the programs on the CD Rom to start automatically as soon as the card is detected in the drive by the host computer. The autostart feature is supported by most 32 bit and higher operating systems.

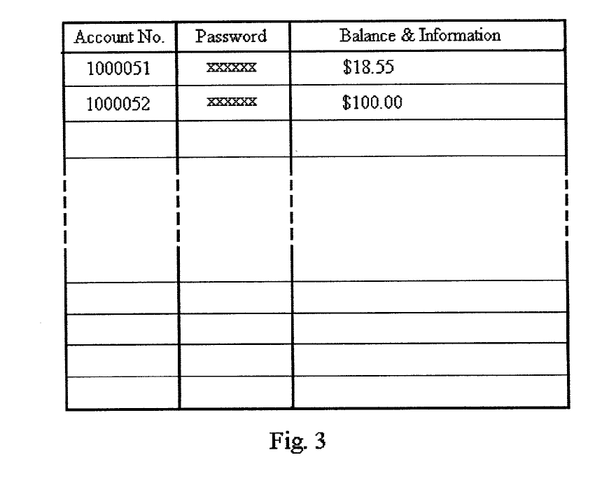

Reference is now made to FIG. 3, which shows in schematic form the storage of account data at a server. A series of accounts are preferably stored as a series of multiple fields each having an identification field, a password, and a field for variable data associated with the card, such as a transaction amount. A host computer supplied with a prepaid card is able to access only the account for which it has the correct identification data and key. The encryptor 26 is preferably operable to ensure that this information is not made available to eavesdroppers and ideally the information is encrypted differently in successive sessions to close the option of simply replicating previously encrypted data.

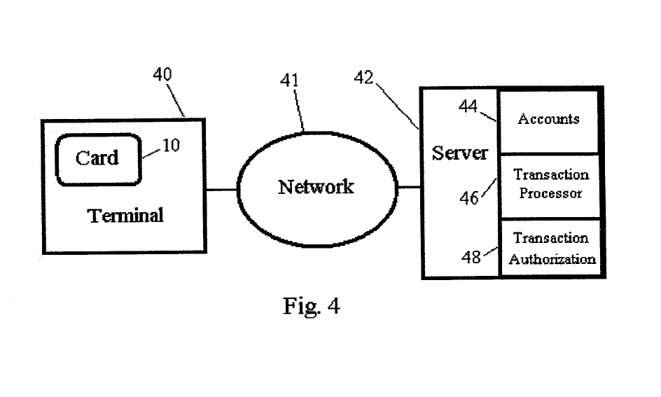

Reference is now made to FIG. 4, which is a simplified diagram showing a system including a card connected via a terminal and a network to a server. A prepaid card 10 is inserted into a host computer 40 where it automatically launches a connection over a network 41 to a web presence of a server 42, as explained above. The server stores account data 44 associated with the different cards 10 as explained above in connection with FIG. 3.

The server further comprises a transaction processor 46 which is operable to support transactions using the accounts 44, for example to debit the account and to credit the account of a vendor. Preferably there is also provided the possibility of supporting the ability of the user to interrogate his account to see the remaining balance and other useful information. A transaction authorization unit 48 preferably provides the ability to decrypt communications received from the cards, to verify account numbers and passwords and to make the relevant account available to the respective card.

A further safeguard feature is provided in a particularly preferred embodiment of the specification. The cards are preferably delivered in batches to a vendor for selling on to the public. Whilst individual cards may not be all that valuable and not worth the effort of stealing, an entire batch is another matter. There is thus provided the feature of initially disabling all of the cards in a batch, preferably at the transaction authorization unit 48. The vendor is then given a secret key or password, and when he opens a new batch he takes out one of the cards 10 and uses it to connect to the server. As this is an, as yet, unauthorized batch, the vendor is prompted for the key. If the key is successfully received then the batch is authorized.

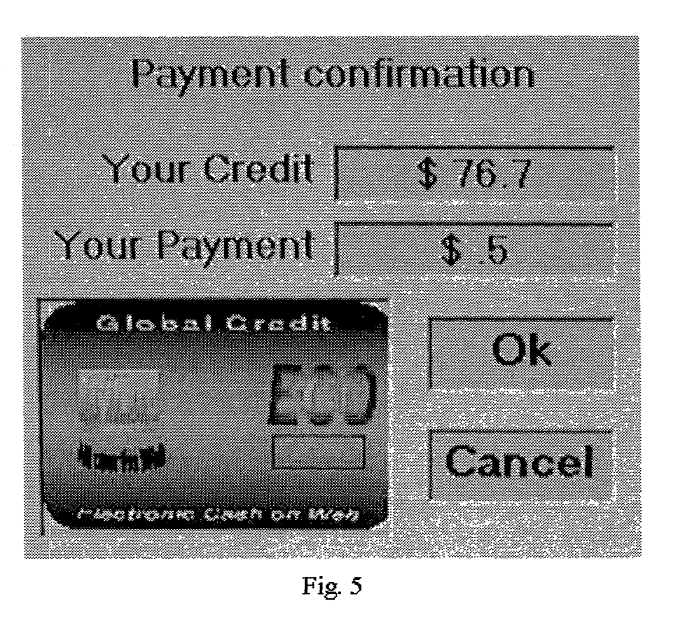

Reference is now made to FIG. 5, which shows a screen that may be presented to the transaction parties in order to carry out a transaction. It will be noted that the screen is set out as a form and that it is not necessary to enter any details of the purchaser. The card automatically connects to the relevant prepaid account. The form requests details of the transaction amount and who the beneficiary is to be. In addition, options are present in the form of radio buttons for obtaining conditions of the transaction and for requesting a remaining balance.

There is thus provided a device for electronic cash which is preferably anonymous, simple to use, that is to say virtually automatic, compatible with most Internet terminals and secure. Users simply purchase a card to a given value, place the card in the terminal and enter the amount of the purchase. The device is thus suitable for purchases of any size including micropurchases.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Apparatus for anonymous remote transactions over a network comprising
a computer readable data unit,
a host storing a record of a sum of money associated with said- computer readable data unit, and
a transaction unit for identifying said associated record at said host on the basis of data obtained from said computer readable data unit, and debiting said associated record in accordance with a transaction being carried out by a user.

2. Apparatus according to claim 1, wherein said computer readable data unit is embodied on substantive media.

3. Apparatus according to claim 1, wherein said computer readable data unit is operable to issue encrypted data readable only by said transaction unit.

4. Apparatus according to claim 1, wherein said computer readable data unit is operable to issue data readable only at said host.

5. Apparatus according to claim 1, wherein said information obtained from said computer readable data unit is information indicative only of said associated record.

6. Apparatus according to claim 1, wherein said computer readable data unit comprises operating software operable to manage said transaction automatically at a user end computer.

7. Apparatus according to claim 6, wherein said operating software is operable to permit said transaction to be carried out with a single user data interaction.

8. Apparatus according to claim 6, wherein said operating program is operable to start automatically upon insertion of said computer readable data unit into a user end computer.

9. Apparatus according to claim 1 wherein said associated record indicates prepaid cash.

10. Apparatus according to claim 9, wherein said prepaid cash is renewable.

11. Apparatus according to claim 1 wherein said computer readable data unit is one of a group comprising a CD Rom, a DVD Rom and a minidisk Rom.

12. Apparatus according to claim 1, wherein the computer readable data unit is substantially the size of a credit card.

13. Apparatus according to claim 1, wherein the computer readable data unit is substantially the shape of a credit card.

14. Apparatus according to claim 1, wherein the computer readable data unit is one of a batch of such units, said batch having an initialization member and wherein the batch is activatable by means of use together with a password of said initialization member.

15. Apparatus according to claim 7, wherein said single data interaction is operable to initiate at least one of a group of activities comprising:
opening a network contract,
indicating conditions of a contract,
confirming acceptance of contract conditions,
sending a request to make a payment to a supplier, and
obtaining details of an account to credit.

16. Apparatus according to claim 15, wherein said group of activities further comprises the use of an electronic signature.

17. Apparatus according to claim 1, wherein said host is operable to show to a user over a network a balance remaining, said balance being indicated by said associated record.

18. Apparatus according to claim 1, wherein said data obtained is unchanged throughout the life of the computer readable data unit but wherein said unit comprises an encrypting unit operable to encrypt said data in different ways.

19. Apparatus according to claim 1, wherein said computer readable data unit comprises an encrypting unit operable to encrypt said data obtained, which said encryption unit is operable to add random bits to said data prior to encrypting said data.

20. A prepaid transaction unit representing prepaid electronic cash units for use in remote transactions, which card is embodied on a machine readable media in association with operating software for supporting said transaction.

21. A prepaid transaction unit according to claim 20, further comprising automatic activation for automatically activating said operating software on insertion of said prepaid transaction unit into a reader of an electronic computer.

22. A prepaid transaction unit according to claim 20, wherein said operating software further comprises a network access unit for accessing a server via a network to allow said software to determine the current value of remaining prepaid cash units associated with said card, said current value being located on said server.

23. A prepaid transaction unit according to claim 22, wherein said software is further operable to update said current value in the light of a present transaction.

24. A prepaid transaction unit according to claim 23, wherein said software is further operable to obtain details of an account associated with a beneficiary of said present transaction and to credit said account.

25. A prepaid transaction unit according to claim 20, further comprising a secret key for accessing said current value at said server.

26. A prepaid transaction unit according to claim 20, further comprising a secret key for accessing said server.

27. A prepayment card on computer readable media.

28. A prepayment card according to claim 27, further comprising software for activating a computer on which said card is inserted, to connect via a network to a server to update an account located on said server and associated with said prepayment card.

29. A method of activating a prepayment card associated with an account at a server, which card is one of a consignment of prepayment cards, comprising the steps of
initially blocking access by said card to said associated account,
selecting an enabler key,
connecting to said server using said selected enabler key,
using said key via said connection,
enabling access by said card to said associated account upon use of said key.
